(19) United States
(12) Patent Application Publication
(10) Pub. No.: US 2020/0321719 A1
(43) Pub. Date: Oct. 8, 2020

(54) TERMINAL FITTING

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Toshiro SAKAI, Mie (JP); Shigeru OGIHARA, Mie (JP)

(21) Appl. No.: 16/955,134

(22) PCT Filed: Dec. 6, 2018
(86) PCT No.: PCT/JP2018/044827

§ 371 Date: Jun. 18, 2020

(30) Foreign Application Priority Data
Dec. 25, 2017 (JP) 2017-247467

(51) Int. Cl. H01R 13/03; C22C 21/06; B32B 15/01

(52) U.S. Cl. CPC H01R 13/03; C22C 21/06; H01R 12/58; B32B 2457/00; B32B 15/017

(57) ABSTRACT

Provided is a terminal fitting comprising a substrate of an aluminum alloy having excellent strength and workability. A terminal fitting 10 comprises a substrate of an aluminum alloy containing 4.0 to 6.0 mass % of Mg and having 0.2% yield strength at 290 to 330 MPa. Preferably the breaking elongation of the aluminum alloy is 10% or greater and the average crystal particle diameter of the aluminum alloy is 10 μm or smaller. Preferably the aluminum alloy further contains 0.4 to 1.8 mass % of Mn.

### TECHNICAL FIELD

The present invention relates to a terminal fitting, and more specifically relates to a terminal fitting that includes an aluminum alloy as a base material.

### BACKGROUND

Conventionally, copper, copper alloys, and copper and copper alloys provided with a metal coating layer made of tin, a tin alloy, or the like on the surfaces thereof have generally been widely used as materials constituting terminal fittings used in electrical connection. However, in recent years, there has been strong demand for reducing the material cost and reducing the weight of terminal fittings used in wire harnesses for automobiles and the like, and consideration has been given to using, as a material of a terminal fitting, aluminum or aluminum alloys that are cheaper and lighter than copper and copper alloys.

Patent Document 1 discloses that a connector terminal used in a substrate connector is constituted by an aluminum material, for example. Examples of the aluminum material used include 5000-series aluminum alloys. In Patent Document 1, the amount of spring back after bending processing is performed is likely to be larger in an aluminum material than in copper or copper alloys, and thus attempts have been made to reduce the amount of spring back by performing bending processing multiple times to reduce the bending angle each time bending is performed, at a linking portion located between a fitting portion that is electrically connected to a counterpart connector terminal and a substrate connection portion that extends in a direction orthogonal to the fitting portion and is electrically connected to a circuit board.

### PRIOR ART DOCUMENT

### Patent Document

Patent Document 1: JP 2017-098035A

### SUMMARY OF THE INVENTION

### Problems to be Solved

As described above, if an aluminum alloy is used as a base material of a terminal fitting, the workability needed for processing a terminal fitting to a predetermined shape is likely to be low, compared to copper and copper alloys. Although it is possible to somewhat make up for low workability of the material by devising the shape of a terminal fitting, similarly to the bent structure of the linking portion disclosed in Patent Document 1, it is important to increase the workability of an aluminum alloy that serves as a base material.

On the other hand, in order to use an aluminum alloy as the base material of a terminal fitting, the aluminum alloy needs to have sufficient strength to withstand use as a terminal fitting. There is demand for an aluminum alloy that has strength that is equivalent or close to that of copper or a copper alloy that has been conventionally and generally used as the base material of a terminal fitting. In a conventional and general aluminum alloy, it is difficult to realize the strength and workability needed for the application as a terminal fitting.

The present invention aims to provide a terminal fitting that includes, as a base material, an aluminum alloy that has high strength and workability.

### Means to Solve the Problem

In order to resolve the above-described issues, a terminal fitting according to the present invention comprises, as a base material, an aluminum alloy that contains Mg in an amount of 4.0 mass % to 6.0 mass % inclusive and that has a 0.2% proof stress of 290 MPa to 330 MPa inclusive.

Here, the aluminum alloy preferably has a breaking elongation of 10% or more.

Also, the aluminum alloy preferably has an average crystal grain size of 10 μm or less.

The aluminum alloy preferably further contains Mn in an amount of 0.4 mass % to 1.8 mass % inclusive.

It is preferable that the terminal fitting has a coating layer that covers at least a portion of a surface of the base material, is exposed at an outermost surface, and is made of tin or a tin alloy.

It is preferable that the terminal fitting is a male terminal that is capable of being fitted to a female terminal, the terminal fitting comprises a terminal connection portion configured to be electrically connected to the female terminal, a substrate connection portion configured to be inserted into a through-hole of a circuit board and be electrically connected to the through-hole through soldering, and a linking portion configured to link the terminal connection portion and the substrate connection portion, and the linking portion has a bending portion.

### Effect of the Invention

The terminal fitting according to the above-described aspect is a terminal fitting whose base material has high material strength and rollability due to the aluminum alloy containing Mg in an amount of 4.0 mass % to 6.0 mass % inclusive. Also, the strength required of a terminal fitting is ensured due to the aluminum alloy having a 0.2% proof stress of 290 MPa or more. On the other hand, as a result of the aluminum alloy having a 0.2% proof stress of 330 MPa or less, the occurrence of cracks during machining such as bending processing is suppressed, and the workability needed for manufacturing a terminal fitting through bending processing and the like can be ensured.

Here, if the aluminum alloy has a breaking elongation of 10% or more, in particular, the workability in machining such as bending processing can be ensured.

Also, if the aluminum alloy has an average crystal grain size of 10 μm or less, the proof stress and breaking elongation of the aluminum alloy can be improved.

If the aluminum alloy further contains Mn in an amount of 0.4 mass % to 1.8 mass % inclusive, the strength and proof stress of the aluminum alloy can be improved because minute precipitates form in the alloy structure due to the aluminum alloy containing Mn in an amount of 0.4 mass % or more. On the other hand, as a result of the Mn content being reduced to 1.8 mass % or less, it is possible to avoid the formation of coarse precipitates and a decrease in bendability.

If the terminal fitting has a coating layer that covers at least a portion of a surface of the base material, is exposed at the outermost surface, and is made of tin or a tin alloy, the strength of the aluminum alloy, which is the base material, can be easily kept high even at high temperatures, and thus the strength of the base material is unlikely to decrease even if a tin or tin alloy layer is formed on the surface of the base material and heated when subjected to a reflow process. As a result, it is possible to avoid unintended deformation of the base material in a process for forming a coating layer, including a reflow process, and a subsequent process for processing the terminal fitting.

The terminal fitting is a male terminal that is capable of being fitted to a female terminal, the terminal fitting including a terminal connection portion configured to be electrically connected to the female terminal, a substrate connection portion configured to be inserted into a through-hole of a circuit board and be electrically connected to the through-hole through soldering, and a linking portion configured to link the terminal connection portion and the substrate connection portion, in which, if the linking portion has a bending portion, it is possible to obtain sufficient substrate strength as a male terminal for substrate connection of such a type, and to ensure high manufacturability in the manufacturing of a male terminal including the formation of a bending portion through bending processing. Also, electrical connection characteristics and soldering wettability of the terminal connection portion and the substrate connection portion can be improved by forming the coating layer made of tin or a tin alloy on the surface of the base material, and the base material is unlikely to deform even if a reflow process is performed when forming such a coating layer.

### BRIEF DESCRIPTION OF THE DRAWINGS

FIG. 1 is a cross-sectional view showing a configuration of a substrate connector that includes a male terminal according to one embodiment of the present invention.

FIG. 2 is a cross-sectional view showing a configuration of materials of the above-described male terminal.

### DETAILED DESCRIPTION TO EXECUTE THE INVENTION

Hereinafter, a terminal fitting according to one embodiment of the present invention will be described in detail with reference to the drawings.

[Overview of Terminal Fitting]

First, an overview of the male terminal will be described using, as one example, the terminal fitting according to one embodiment of the present invention.

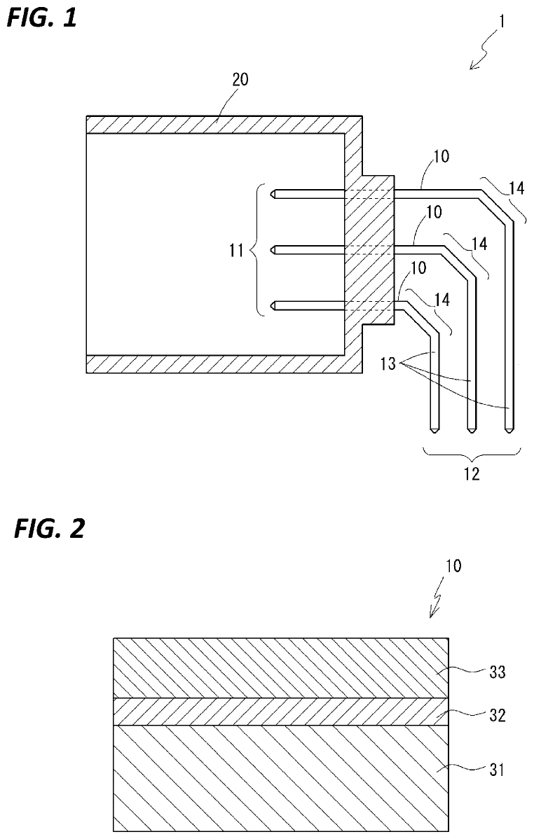

Although specific shapes and applications of the terminal fitting according to an embodiment of the present invention are not particularly limited, the structure of a male terminal 10 that constitutes a substrate connector will be described in simple terms below as one example. The structure of a substrate connector 1 that includes such male terminals 10 is shown in FIG. 1. The male terminals 10 each have a structure that is similar to that of the connector terminal disclosed in Patent Document 1.

The male terminal 10 is configured as an elongated member obtained by press punching a plate-shaped metal material in which an aluminum alloy is used as a base material, and the male terminal 10 has a terminal connection portion 11 at one end of the male terminal 10, and has a substrate connection portion 12 at the other end thereof. The terminal connection portion 11 is configured as a tab-shaped male electrical connection portion, and is to be fitted and connected to a counterpart female terminal formed in a box shape or the like, thus forming an electrical connection with the female terminal. On the other hand, the substrate connection portion 12 is configured as a pin-shaped electrical connection portion, and is to be inserted into a through-hole formed in a circuit board. A conductive contact portion that is connected to a conductive path formed on the circuit board is formed on an inner circumferential surface of the through-hole, and by performing soldering on the substrate connection portion 12 inserted into the through-hole, an electrical connection can be formed between the substrate connection portion 12, the contact portion formed on the inner circumferential surface of the through-hole, and the conductive path of the circuit board.

A linking portion 13 is provided between the terminal connection portion 11 and the substrate connection portion 12, and the terminal connection portion 11 and the substrate connection portion 12 are integrally connected to each other via the linking portion 13. The linking portion 13 has a bending portion 14 at an intermediate portion thereof, and, as a result of the constituent material of the male terminal 10 being bent at the bending portion 14, the terminal connection portion 11 and the substrate connection portion 12 extend in directions in which the terminal connection portion 11 and the substrate connection portion 12 are substantially orthogonal to each other. Here, the bending portion 14 has a stepped configuration, and the linking portion 13 is bent into multiple steps (two steps in the form shown in FIG. 1).

A plurality of male terminals 10 can be fixed to a shared connector housing 20 made of a resin, and be used as the substrate connector 1. The terminal connection portions 11 of the male terminals 10 are connected to counterpart female terminals and the substrate connection portions 12 are connected to through-holes of the circuit board, thus forming electrical connections between the conductive path of the circuit board and the counterpart female terminals via the male terminals 10.

Note that, in the form shown in FIG. 1, bending is performed multiple times on the bending portion 14 formed at an intermediate portion of the linking portion 13 located between the terminal connection portion 11 and the substrate connection portion 12, and thus processing for bending the aluminum alloy that constitutes the male terminal 10 can be performed with ease. However, as will be described below, the aluminum alloy that serves as the base material of the male terminal 10 according to this embodiment has good workability in bending processing and the like, and, as will be described in examples, cracks are unlikely to occur even if the aluminum alloy is bent at 90 degrees, and thus a configuration may be adopted in which the bending portion 14 has a single step structure and bending is performed at 90 degrees in a single operation. Also, the bent structure can be provided at another portion of the male terminal 10, and the terminal connection portion 11 and the substrate connection portion 12 may be processed into a desired shape for an electrical connection portion by not only punching but also bending a plate material, for example.

[Constituent Material of Terminal Fitting]

Next, a metal material that constitutes the terminal fitting according to this embodiment will be described.

A terminal fitting such as the male terminal 10 according to this embodiment includes an aluminum alloy, which will be described in detail below, as a base material. Also, a coating layer made of another metal, an organic material, or the like can be provided as appropriate by coating a portion of the surface of the base material that constitutes a terminal fitting such as the male terminal 10 in order to impart the surface of the base material with characteristics and the like. One example of the configuration of the metal material that has such coating layers is shown in FIG. 2.

A nickel layer 32 that is in contact with a surface of the base material 31 and is made of nickel or a nickel alloy is provided in the configuration shown in FIG. 2. Also, a tin layer 33 that is in contact with a surface of the nickel layer 32, is exposed at the outermost surface, and is made of tin or a tin alloy is provided.

It is preferable that, in the male terminal 10 shown in FIG. 1, a coating layer having a layered structure including the nickel layer 32 and the tin layer 33 such as that shown in FIG. 2 is formed at least on the surface of the base material 31 at the terminal connection portion 11 and the substrate connection portion 12. Although a hard and thick oxide film is likely to form on the surface of the base material 31 because the aluminum alloy is a relatively active metal, the tin layer 33 is soft and can break a thin oxide film formed on the surface with a low contact load, and thus, as a result of the tin layer 33 being exposed at the outermost surface of the terminal connection portion 11, electrical contact can be stably and reliably formed at the time of fitting and connection to a counterpart female terminal. Also, although the oxide film formed on the surface of the aluminum alloy of the base material 31 reduces the soldering wettability of the base material 31, because the tin layer 33 is exposed at the outermost surface of the substrate connection portion 12, the soldering wettability at the substrate connection portion 12 can be ensured, and an electrical connection with a through-hole of the circuit board can be stably and reliably formed through soldering. It is preferable to perform a reflow process on the tin layer 33. The reflow process makes it possible to improve the heat resistance of the tin layer 33 and suppress the formation of whiskers. The tin layer 33 may be provided only on the surfaces of the terminal connection portion 11 and the substrate connection portion 12, or may be provided on the entire surface of the male terminal 10.

As described above, a hard and thick oxide film is likely to form on the surface of the aluminum alloy of the base material 31, and thus it is difficult to directly form the tin layer 33 on the surface thereof through plating or the like, and the adherence between the base material 31 and the tin layer 33 will also be low. In view of this, the adherence of the tin layer 33 to the base material 31 can be improved as a result of nickel forming alloys with tin and aluminum due to the nickel layer 32 being provided between the base material 31 and the tin layer 33. Although the nickel layer 32 may be provided only in a region for forming the tin layer 33 if the tin layer 33 is to be formed only on the surfaces of the terminal connection portion 11 and the substrate connection portion 12, the nickel layer 32 is preferably provided on the entire surface of the male terminal 10. Accordingly, the corrosion resistance of the male terminal 10 can be improved. In this case, the nickel layer 32 is exposed at the outermost surface in a region where no tin layer 33 is formed.

From the viewpoint of sufficiently obtaining the above-described effects, the nickel layer 32 and the tin layer 33 each preferably have a thickness of 0.3 μm or more, and preferably have a total thickness of 1 μm or more together. On the other hand, from the viewpoint of avoiding an excessive increase in the thickness of the coating layer, it is preferable that the nickel layer 32 and the tin layer 33 each have a thickness of 1.0 μm or less, and the total thickness thereof is reduced to 3 μm or less.

[Aluminum Alloy that Constitutes Base Material]

The base material 31 that constitutes a terminal fitting such as the male terminal 10 according to this embodiment is made of an aluminum alloy as described below.

(Component Composition)

This aluminum alloy contains Mg in an amount of 4.0 mass % to 6.0 mass % inclusive.

(1) Addition of Mg

As a result of adding Mg to aluminum, strain is likely to accumulate in the aluminum alloy, and work hardening effectively occurs. Also, crystal grains of the aluminum alloy are likely to be refined. As a result, the strength and the breaking elongation of the aluminum alloy can be increased. High room temperature strength required of a terminal fitting such as the male terminal 10 can be obtained by setting the Mg content to 4.0 mass % or more. From the viewpoint of obtaining particularly high strength, the Mg content is more preferably 4.5 mass % or more.

Also, Mg atoms act as viscous resistance to mobile dislocations in the aluminum alloy, and thus the Mg atoms also contribute to suppressing a decrease in the strength thereof at high temperatures. If the Mg content is 4.0 mass % or more, or 4.5 mass % or more, high strength can be maintained even at a high temperature of 200° C. or more.

On the other hand, if the Mg content is excessively high, the rollability of the aluminum alloy, that is, hot rollability and cold rollability, decreases. The rollability of this aluminum alloy is sufficiently increased due to the Mg content being reduced to 6.0 mass % or less. As a result, it is possible to ensure the manufacturability of terminal fittings and to reduce the manufacturing cost. In particular, from the viewpoint of obtaining particularly high manufacturability, the Mg content is more preferably 5.5 mass % or less.

The aluminum alloy may contain only Mg as an additive element, and the remaining portion may include Al and inevitable impurities, or may contain an additive element other than Mg, in addition to Mg. Examples of the additive element other than Mg include the following.

(2) Addition of Mn

The aluminum alloy preferably contains Mn, in addition to Mg. As a result of adding Mn to the aluminum alloy, relatively large Al—Mn-based intermetallic compounds and minute precipitates are likely to form. Of these substances, the minute precipitates contribute to improving strength and proof stress of the aluminum alloy through dispersion strengthening. Also, coarsening of recrystallized grains can be suppressed due to the pinning effect. From the viewpoint of sufficiently obtaining dispersion strengthening and the pinning effect of recrystallized grains, the aluminum alloy preferably contains Mn in an amount of 0.4 mass % or more, and more preferably contains Mn in an amount of 0.7 mass % or more.

On the other hand, if a large number of large Al—Mn-based intermetallic compounds are formed, the Al—Mg-based intermetallic compounds are likely to serve as starting points of cracks in bending processing, which may reduce the bendability of the aluminum alloy. In view of this, from the viewpoint of suppressing cracks in bending processing, the aluminum alloy preferably contains Mn in an amount of 1.8 mass % or less, and more preferably 1.5 mass % or less.

(3) Addition of Other Elements

The aluminum alloy may contain one or more additive elements as described below, in addition to Mg, or in addition to Mg and Mn.
Fe≤0.2 mass %
Cre≤0.2 mass %
Zr≤0.2 mass %
Sc≤0.1 mass %
Si≤0.1 mass %
Zn≤0.1 mass %
Ti≤0.1 mass %
Cu≤0.1 mass %

Crystal grain refinement, dispersion strengthening, and precipitation strengthening effects can be obtained by adding the above-described elements. Because these phenomena effectively occur even if a small amount of each element described above is added, the lower limit of the amount of an element to be added is not particularly set. On the other hand, it is preferable that the amount of each element to be added is kept within the above-described upper limit because, when an element is added exceeding the above-described upper limit, coarse precipitates and crystallized substances are likely to form, and crystal grain refinement, dispersion strengthening, and precipitation strengthening effects are less likely to be obtained, and coarse precipitates and crystallized substances may serve as starting points of cracks in a forming process, and the formability of the aluminum alloy is likely to decrease.

Also, from the viewpoint of ensuring strength at room temperature and high temperatures, and maintaining minute crystal grains, it is desired that the total added amount of Mg, Mn, and each element (referred to as an “element A”) of the above-described Fe, Cr, Zr, Sc, Si, Zn, Ti, and Cu satisfies 5.0%<[Mg]+[Mn]+[A]≤5.5%. It is desired that the same applies to a case where the aluminum alloy does not contain Mn (5.0%<[Mg]+[A]≤5.5% is satisfied).

This aluminum alloy may contain inevitable impurities in an amount that does not affect the above-described characteristics. The aluminum alloy may contain each type of metal element in an amount of less than 0.05 mass % as long as the total amount of the elements is less than about 0.1 mass %.

(Crystal Structure)

It is preferable that this aluminum alloy has an average crystal grain size of 10 μm or less, and 7 μm or less. Both the proof stress and elongation of the aluminum alloy can be improved by refining crystal grains. The proof stress required of a terminal fitting such as the male terminal 10, and the strength needed at room temperature and high temperatures can be obtained by reducing the average crystal grain size of this aluminum alloy to the above-described value or less. At the same time, the workability of a terminal fitting such as the male terminal 10 required for bending processing and the like can be ensured by improving elongation.

Refinement of the average crystal grain size can be achieved by adding Mg in an amount of the above-described predetermined lower limit or more and controlling the component composition of the aluminum alloy. The average crystal grain size also depends on the conditions under which an aluminum alloy is manufactured, and crystal grains can also be refined by increasing the rolling ratio at the time of rolling the aluminum alloy.

The smaller the crystal grain size is, the greater the effect of improving the proof stress and elongation of the aluminum alloy is, and thus the lower limit of the average crystal grain size is not particularly set. However, the lower limit of a substantial average crystal grain size needed for industrially manufacturing an aluminum alloy is about 5.0 μm. Also, if the average crystal grain size is 5.0 μm or more, it is unlikely that the proof stress will excessively increase and the workability of the aluminum alloy will decrease.

The average crystal grain size of the aluminum alloy can be evaluated by observing the structure thereof using a scanning electron microscope (SEM), for example. It is sufficient to set an average value of the equivalent circle diameters of crystal grains as the average crystal grain size.

(Physical Characteristics)

It is preferable that this aluminum alloy has physical characteristics such as the following. Note that each physical property value refers to a value measured in an atmosphere at room temperature in this specification, unless otherwise specified.

(1) 0.2% Proof Stress

The 0.2% proof stress refers to an amount serving as an index of the strength of a metal material, and this aluminum alloy preferably has a 0.2% proof stress of 290 MPa or more. Accordingly, the aluminum alloy has strength high enough to withstand use as a terminal fitting such as the male terminal 10, and when the aluminum alloy is used in the terminal fitting, damage to the base material 31, such as breakage, can be avoided. The 0.2% proof stress of 290 MPa or more is equivalent or close to that of brass or a Corson alloy used as the base material of a terminal fitting such as a conventionally general male terminal. The aluminum alloy more preferably has a 0.2% proof stress of 300 MPa or more in order to obtain particularly high strength.

On the other hand, the 0.2% proof stress of this aluminum alloy is preferably reduced to 330 MPa or less. If the proof stress of the aluminum alloy is excessively high, it is difficult to perform forming thereon. In particular, cracks are likely to occur due to the formation of shear bands during bending processing. However, as a result of the 0.2% proof stress of the aluminum alloy being reduced to 330 MPa or less, the workability required in processing performed to manufacture a terminal fitting such as the male terminal 10, such as bending processing performed on the bending portion 14 shown in FIG. 1, can be easily ensured. As will be described using examples below, the occurrence of cracks can also be easily avoided when bending is performed at 90 degrees. Note that, although the terminal fitting according to this embodiment of the present invention is not limited to a male terminal, normally, the male terminal has a relatively simple shape among various terminal fittings including a female terminal, and thus if the terminal fitting is a male terminal, as a result of the 0.2% proof stress being set to 330 MPa or less, the terminal fitting can be processed to a predetermined shape with particular ease while avoiding damage such as cracks. From the viewpoint of ensuring particularly high workability, the 0.2% proof stress is more preferably 320 MPa or less.

In this manner, as a result of the aluminum alloy having a 0.2% proof stress of 290 MPa to 330 MPa inclusive, high strength and high workability of a terminal fitting such as the male terminal 10 can be achieved. The 0.2% proof stress depends on the component composition of the aluminum alloy. The 0.2% proof stress can be improved by increasing the amount of added Mg or Mn, for example. Also, the 0.2% proof stress can be easily improved by adding Cr, Fe, Zr, Sc, or the like.

The 0.2% proof stress can be adjusted according to the conditions under which the aluminum alloy is manufactured. The 0.2% proof stress can be adjusted according to the rolling ratio used in cold rolling, for example. As will be described later, although a cold rolling process is performed after a hot rolling process in order to make a plate-shaped aluminum alloy have a predetermined final thickness, from the viewpoint of achieving a 0.2% proof stress of 290 MPa to 330 MPs inclusive, the final cold rolling ratio is preferably set to 30% to 80% inclusive in order to effectively obtain work hardening and to refine the crystal grain size. The final cold rolling ratio is more preferably 45% to 75% inclusive. Note that intermediate annealing may be performed before or during cold rolling, or before and during cold rolling. Examples of conditions for intermediate annealing include 300° C. to 400° C. for about 1 to 5 hours.

The 0.2% proof stress of the aluminum alloy, and breaking elongation and tensile strength that will be described later can be evaluated through tensile testing conforming to JIS Z 2241, for example.

(2) Breaking Elongation

As the breaking elongation of the aluminum alloy increases, higher workability can be ensured in machining such as bending processing. Breaking elongation is preferably 10% or more. Processing can be easily performed on the aluminum alloy to achieve a shape required of a terminal fitting such as the male terminal 10, while avoiding damage such as cracks resulting from bending. Breaking elongation is particularly preferably 12% or more. Because higher breaking elongation is preferable, the lower limit is not particularly set.

(3) Tensile Strength

Tensile strength of a metal material refers to an amount that indicates a load applied to a material until the material breaks. On the other hand, the 0.2% proof stress refers to an amount that indicates a load applied thereto at the elastic limit thereof. Thus, as the difference between the tensile strength and the 0.2% proof stress increases, it is more likely that the metal material will exhibit higher elongation, and the workability in bending processing or the like will increase. From this viewpoint, the difference between the tensile strength and the 0.2% proof stress of the aluminum alloy (tensile strength-0.2% proof stress) is preferably 60 MPa or more, and 100 MPa or more.

(4) High-Temperature Strength

Although this aluminum alloy has high strength at room temperature as described above, even in a state in which the aluminum alloy is heated to a high temperature, high strength can be maintained due to the effects resulting from the aluminum alloy containing a predetermined amount of Mg or more, for example. Even in a state in which the aluminum alloy is heated to 200° C. or more, for example, it is possible to avoid deformation of the aluminum alloy. The high-temperature strength of the aluminum alloy can also be improved by refining crystal grains.

Even if the base material 31 that constitutes a terminal fitting such as the male terminal 10 is heated in the process for manufacturing the terminal fitting or in use of the terminal fitting, the base material 31 of the terminal fitting is unlikely to deform, for example, due to the aluminum alloy having high high-temperature strength. In particular, as described above, if the tin layer 33 is formed on the surface of the base material 31 in order to improve electrical connection characteristics and ensure soldering wettability, it is advantageous that the aluminum alloy has high high-temperature strength, from the viewpoint of performing a reflow process on the tin layer 33.

In order to improve heat resistance and whisker resistance, it is preferable to perform a reflow process on the tin layer 33 at the melting point of tin (232° C.) or more. At this time, if the aluminum alloy of the base material 31 does not have sufficient high-temperature strength, a terminal fitting such as the male terminal 10 to be manufactured may undergo unintended deformation. Although heating performed in a reflow process performed on a tin layer is unlikely to cause issues because copper or a copper alloy that has been conventionally and generally used as the base material of a terminal fitting has a high melting point, generally, because the aluminum alloy has a low melting point of about 600° C., there is a possibility that the proof stress will significantly decrease and the material thereof will deform due to heating at the melting point of tin or more that is performed in the reflow process. Such deformation is likely to occur depending on the weight of the material or the load applied to the material during conveyance in a heating treatment line, for example. However, as a result of this aluminum alloy being used as the base material 31 of a terminal fitting such as the male terminal 10, high high-temperature strength can be obtained due to the effect obtained by the aluminum alloy containing Mg in a predetermined amount or more, and the base material 31 is unlikely to deform even through heating in the reflow process or the like.

[Method for Manufacturing Terminal Fitting]

Next, a method for manufacturing a terminal fitting such as the male terminal 10 according to this embodiment will be described.

(Manufacturing of Aluminum Alloy)

First, an aluminum alloy that constitutes the base material 31 is manufactured. The aluminum alloy can be manufactured through the following processes.

(1) Casting Process

This aluminum alloy can be manufactured by first preparing an alloy molten metal having a predetermined component composition and casting the prepared alloy molten metal. Although DC casting (Direct Chill Casting), which is a common semicontinuous casting method, can be suitably used, the casting method is not particularly limited, and roll casting that is a continuous casting method, or the like may be used. A cutting process may be performed as appropriate on an ingot obtained through casting to remove an ununiform layer formed on the surface thereof.

(2) Homogenization Process

It is preferable to perform a homogenization process on the ingot obtained above to eliminate segregation in the ingot. Homogenization may be performed by holding the ingot in an atmosphere having a temperature of 400° C. to 560° C. for 0.5 to 24 hours, for example. Setting the processing temperature to 400° C. or more is likely to sufficiently facilitate homogenization. On the other hand, setting the processing temperature to 560° C. or less is likely to prevent a deterioration in the quality caused by the occurrence of eutectic melting. Also, setting the processing time to 0.5 hours or more is likely to sufficiently eliminate segregation. On the other hand, saturation of the homogenization effect can be avoided by setting the processing time to 12 hours or less. Preferably, the homogenization process is performed in an atmosphere having a temperature of 500° C. or more for 0.5 to 12 hours.

(3) Hot Rolling Process

By performing a hot rolling process on the material subjected to the homogenization process as appropriate, the structure can be refined and uniformized, and the material is formed into a predetermined thickness. The starting temperature of the hot rolling process may be the same temperature at which the homogenization process is performed, or the homogenization process may be utilized as pre-heating performed before the hot rolling process is performed.

The finishing temperature of hot rolling is preferably set to 250° C. or more. By setting the finishing temperature to 250° C. or more, the deformation resistance of the aluminum alloy is reduced, and rolling can be easily performed. Hot rolling is usually performed in multiple passes, and the rolling ratio of the final pass may be set to 30% or more, or preferably to 40% or more. As a result of setting the rolling ratio to a such value, a structure into which strain is uniformly introduced through the final pass is likely to be obtained.

(4) Cold Rolling Process

The aluminum alloy can be rolled to a predetermined final thickness by performing cold rolling after the hot rolling process. In order to introduce strain into the entirety of the material and refine recrystallized grains, the final cold rolling ratio in the cold rolling process is preferably set to 30% to 80% inclusive. The final cold rolling ratio is more preferably 45% to 75% inclusive. If the final cold rolling ratio is less than 30%, it is likely that strain will be ununiform and the refinement of the recrystallized grains will result in impurities. On the other hand, if the final cold rolling ratio exceeds 80%, strain is localized when a forming process is performed on the terminal fitting, and cracks are likely to occur.

(5) Intermediate Annealing Process

Also, intermediate annealing may be performed one or more times before the cold rolling process, and/or during the cold rolling process. The uniformity of the structure can be increased through intermediate annealing. Intermediate annealing is preferably performed by heating the material at a temperature of 300° C. to 400° C. for 1 to 5 hours. If intermediate annealing is performed, work hardening decreases.

(Manufacturing of Terminal Fitting)

Next, a plate material made of the aluminum alloy manufactured in the above-described manner is used as the base material 31, and coating layers such as the nickel layer 32 and the tin layer 33 are formed on the surface thereof as appropriate. A terminal fitting such as the male terminal 10 can be manufactured by forming the base material 31 into a terminal shape through press punching or bending processing, for example.

(1) Formation of Coating Layers

A layered structure including the nickel layer 32 and the tin layer 33 can be produced by forming the nickel layer 32 on a surface of the base material 31 through plating or the like, and forming the tin layer 33 thereon through plating or the like. As described above, a thick oxide film is likely to form on the surface of the base material 31, and thus, when the nickel layer 32 is formed, displacement plating is preferably utilized as appropriate.

It is preferable that heating is performed after the tin layer 33 is formed through plating or the like, and a reflow process is performed in order to improve the heat resistance and whisker resistance of the tin layer 33. The reflow process can be performed through heating at the melting point of tin (232° C.) or more to melt the tin layer 33, and rapidly solidifying the molten tin layer 33. As described above, the aluminum alloy that constitutes the base material 31 has good strength at high temperatures, and thus even if the reflow process is performed, the base material 31 heated to a high temperature is unlikely to deform during the reflow process or in a subsequent process.

(2) Processing for Forming Terminal Shape

Press punching for forming a predetermined terminal shape is performed on the base material 31 on which the coating layers 32 and 33 are formed as appropriate in the above-described manner. At this time, punching may be performed on a plate-shaped base material 31 with a large area after the coating layers constituted by the nickel layer 32 and the tin layer 33 have been formed, or punching may be performed on the base material 31 to form a terminal shape, and the coating layers 32 and 33 may then be formed on the base material 31 having the terminal shape. However, it is preferable to form the coating layers 32 and 33 after punching is performed on the base material 31. This is because, if punching is performed on the plate material provided with the coating layers 32 and 33, a portion that is not covered by the coating layers 32 and 33 and at which the base material 31 is exposed is formed on an end surface (a cut surface) exposed through punching, and the soldering wettability improving effect of the tin layer 33, and the corrosion resistance improving effect of the nickel layer 32 and the like are not obtained at these end surfaces, whereas if the coating layers 32 and 33 are formed after punching is performed on the base material 31, end surfaces that are not covered by the coating layers 32 and 33 are not formed or are reduced.

When multiple male terminals 10 are manufactured, for example, press punching is performed on the base material 31 having a large area into a shape in which a plurality of male terminals 10 are linked together. At this time, the plurality of male terminals 10 are linked to each other by carrier portions, and are connected to each other. It is preferable to provide the carrier portions avoiding portions of the terminal connection portions 11 of the male terminals 10 that are to be fitted to counterpart terminals, and portions of the substrate connection portions 12 on which soldering is performed. It is preferable to provide the linking portion 13 for linking the connection portions 11 and 12 with a carrier portion having a small area. It is sufficient that the nickel layer 32 and the tin layer 33 are subsequently formed through plating or the like in a state in which the plurality of male terminals 10 are linked to each other by the carrier portions in this manner, and a reflow process is performed as needed. From the viewpoint of reducing the manufacturing cost, the plating process and the reflow process are preferably performed not through batch processing but through continuous processing.

The plurality of male terminals 10 need only to be separated from each other at the carrier portions. Although end surfaces that are not covered by the coating layers 32 and 33 and at which the base material 31 is exposed are formed at portions corresponding to the separated carrier portions at this time, the exposure of the end surfaces can be reduced to a small area. Also, as a result of providing the carrier portions so as to avoid the portions of the terminal connection portions 11 that are to be fitted to counterpart terminals and the portions of the substrate connection portions 12 on which soldering is to be performed, it is possible to keep the portions of the base material 31 exposed at the end surfaces from affecting the electrical connection characteristics and soldering wettability at the connection portions 11 and 12.

In this manner, it is likely that deformation of a hot base material 31 obtained after the reflow process due to the weight thereof and the load applied thereto during conveyance will be problematic in a case where press punching is performed such that the plurality of male terminals 10 have a terminal shape in which the male terminals 10 are linked to each other via carrier portions having a small area, and then the plating process and the reflow process are successively performed, compared to a case where the plating process and the reflow process are performed on a base material 31 that has not undergone punching. In particular, because stress is likely to be concentrated on the cross-sections of the carrier portions having a small area, the base material 31 is likely to deform at the carrier portions at high temperatures.

However, the base material 31 made of the above-described aluminum alloy has high high-temperature strength, and thus is unlikely to deform even at a temperature of 200° C. or more at which the reflow process is performed. As a result, even if heating is performed on the material in which a plurality of terminals are connected to each other via the carrier portions, through the reflow process on the tin layer 33 or the like, and conveyance and the like are performed in a state in which the base material 31 is at a high temperature, deformation is unlikely to occur at the carrier portions and portions of the male terminals 10. Thus, even if heating such as the reflow process is involved, male terminals 10 in which deformation from a predetermined shape is suppressed can be efficiently manufactured.

It is sufficient that the male terminals 10 are separated one-by-one at the carrier portions after the reflow process is performed, and bending processing and the like are performed on the bending portions 14. If the substrate connector 1 is obtained as a result of the connector housing 20 holding the male terminals 10, it is sufficient that the male terminals 10 are inserted into the connector housing 20, and the bending portions 14 are formed through bending processing.

### Examples

Examples of the present invention will be described below. Note that the present invention is not limited to these examples.

[Test Method]

(1) Preparation of Sample

Samples of Examples 1 to 6 and Comparative Examples 1 to 5 were prepared by producing, as a plate material having a plate thickness (t) of 0.6 mm, an aluminum alloy that contained component elements shown in Table 1 and whose remaining portion included Al and inevitable impurities. Although the aluminum alloy was manufactured through a homogenization process, hot rolling, and cold rolling, the final rolling ratio in cold rolling and whether or not intermediate annealing (at 300° C. for 1 hour) was performed were selected for each sample as shown in Table 1. Note that the plate thickness of 0.6 mm was set presuming the plate thickness that is typically used for a male terminal for substrate connection such as that shown in FIG. 1.

(2) Evaluation of Physical Characteristics

Tensile testing conforming to JIS Z 2241 was performed on each aluminum alloy in an atmosphere at room temperature, and the 0.2% proof stress, tensile strength, and breaking elongation were evaluated from a stress-strain curve.

(3) Evaluation of Crystal Grain Size

The plate surface of each aluminum alloy was observed using a SEM. The average crystal grain size was then estimated. Observation, measurement of the grain size, and calculation of average values were performed in a visual field of 250 μm×250

(4) Evaluation of Bendability

A bending test was performed on each aluminum alloy. In the bending test, the plate material was bent at 90 degrees in a direction (a TD direction) perpendicular to a rolling direction. Whether cracks occurred on the outer side of the bend was evaluated by visually observing a bent portion and observing the cross-section thereof. A plate material in which no cracks occurred in bending where an inner bending radius (an inner-R) was 0.2 mm (R/t=0.33) was evaluated as having excellent bendability (A). A plate material in which cracks occurred in a bend with an inner-R of 0.2 mm, whereas no cracks occurred in a bend with an inner-R of 0.3 mm (R/t=0.5) was evaluated as having high bendability (B). A plate material in which cracks occurred even in a bend with an inner-R of 0.3 mm was evaluated as having low bendability (C).

(5) Evaluation of High-Temperature Strength

Each aluminum alloy was heated to simulate a tin reflow process, and the high-temperature strength thereof was evaluated. That is, the aluminum alloy was formed into a shape in which a plurality of terminals were linked to each other via carrier portions, a nickel layer having a thickness of 1 μm and a tin layer having a thickness of 1 μm were successively formed thereon in the stated order, and the resulting aluminum alloy material was kept in a reducing atmosphere at 320° C. for 20 seconds. During heating, the aluminum alloy material was kept horizontally in air in a state in which a load (50 N to 150 N inclusive) was applied to the carrier portions. The heated aluminum alloy was then visually observed, and a heated aluminum alloy in which no deformation occurred was evaluated as having high high-temperature strength (A). On the other hand, a heated aluminum alloy in which deformation occurred was evaluated as having low high-temperature strength (B).

[Results]

Table 1 shows the component compositions of the aluminum alloys of Examples 1 to 6 and Comparative Examples 1 to 5, whether or not intermediate annealing was performed in the manufacturing process, the final cold rolling ratios, and the results of evaluations. Note that rolling was unable to be performed on Comparative Example 4 when a plate material was manufactured, and thus a plate-shaped sample for evaluation was unable to be produced, and evaluations were not made.

TABLE 1

| | | | | | | Results of evaluations | | | | | |
|---|---|---|---|---|---|---|---|---|---|---|---|
| | Component | | | | Final cold | 0.2% | Tensile | Breaking | Average crystal | | High- |
| | composition [mass %] | | | Intermediate | rolling ratio | proof stress | strength | elongation | grain size | | temperature |
| | Mg | Mn | Others | annealing | [%] | [MPa] | [MPa] | [%] | [μm] | Bendability | strength |
| Ex. 1 | 5.0 | — | Cr: 0.2 | No | 75 | 290 | 390 | 10 | 5 | A | A |
| | | | Fe: 0.1 | | | | | | | | |
| Ex. 2 | 4.7 | 1.4 | Fe: 0.02 | No | 55 | 300 | 400 | 15 | 7 | A | A |
| Ex. 3 | 4.5 | 1.8 | Fe: 0.03 | Yes | 50 | 290 | 350 | 11 | 10 | A | A |
| Ex. 4 | 5.5 | 0.4 | Zr: 0.2 | No | 65 | 330 | 400 | 12 | 8 | B | A |
| | | | Fe: 0.05 | | | | | | | | |
| Ex. 5 | 4.6 | 0.7 | Cr: 0.2 | No | 55 | 290 | 360 | 14 | 6 | B | A |
| | | | Fe: 0.04 | | | | | | | | |
| Ex. 6 | 6.0 | 1.0 | Sc: 0.1 | No | 45 | 300 | 400 | 10 | 9 | B | A |
| | | | Fe: 0.05 | | | | | | | | |
| Comp. | 2.5 | 0.1 | Cr: 0.2 | No | 90 | 250 | 290 | 8 | 15 | C | B |
| Ex. 1 | | | Fe: 0.15 | | | | | | | | |
| Comp. | 4.5 | 0.3 | Cr: 0.05 | Yes | 55 | 230 | 315 | 14 | 15 | C | B |
| Ex. 2 | | | Fe: 0.2 | | | | | | | | |
| Comp. | 3.0 | 0.7 | Cr: 0.1 | No | 80 | 270 | 330 | 10 | 19 | C | B |
| Ex. 3 | | | Fe: 0.2 | | | | | | | | |
| Comp. | 7.0 | — | Fe: 0.02 | Unable to be rolled | | | | | | | |
| Ex. 4 | | | | | | | | | | | |
| Comp. | 4.5 | 1.7 | Cr: 0.05 | No | 90 | 460 | 500 | 10 | 6 | C | A |
| Ex. 5 | | | Fe: 0.05 | | | | | | | | |

According to the results shown in Table 1, the aluminum alloys of Examples 1 to 6 all contained Mg in an amount of 4.0 mass % to 6.0 mass % inclusive. Also, these aluminum alloys had a 0.2% proof stress of 290 MPa to 330 MPa inclusive. The fact that the 0.2% proof stress was 290 MPa or more indicates that the aluminum alloy has high strength required of a terminal fitting at room temperature. On the other hand, the fact that the 0.2% proof stress was 330 MPa or more indicates that the workability of the aluminum alloy is ensured, which corresponds to the confirmation of high workability in the results of bendability testing.

Also, with all of the examples, the aluminum alloys had a breaking elongation of 10% or more and an average crystal grain size of 10 μm or less. With regard to tensile strength, the difference between the tensile strength and the 0.2% proof stress was 60 MPa or more. These results correspond to high bendability. Also, it was confirmed that, with all of the examples, the aluminum alloys had high high-temperature strength to an extent that they did not deform even when heated to simulate a tin reflow process.

On the other hand, in each comparative example, at least one of the Mg content ranging from 4.0 mass % to 6.0 mass % inclusive, and the 0.2% proof stress ranging from 290 MPa to 330 MPa inclusive was not satisfied.

With Comparative Examples 1 and 3, the Mg content was less than 4.0 mass %. As a result, the average crystal grain size was larger than or equal to 15 μm. Also, the 0.2% proof stress of the aluminum alloy did not reach 290 MPa, in correspondence with an increase in the average crystal grain size. The breaking elongation was also smaller than those of the examples, and sufficient bendability was not obtained in correspondence therewith. Also, the high-temperature strength of the aluminum alloy was also low because the Mg content was low. Note that the component compositions of Comparative Examples 1 and 3 were respectively equivalent to those of JIS A5025 and A5454.

With Comparative Example 2, the aluminum alloy contained Mg in an amount of 4.0 mass % to 6.0 mass % inclusive, whereas the 0.2% proof stress did not reach 290 MPa, and strength required of a terminal fitting was not obtained. It is conceivable that this was because the Mg content was relatively low at 4.5 mass % in the above-described range, and the Mn content that is effective for crystal grain refinement and dispersion strengthening was not high, and work hardening was not sufficient due to intermediate annealing being performed and the final rolling ratio of cold rolling being low. Actually, the average crystal grain size was as large as 19 μm. The bendability and high-temperature strength of the aluminum alloy were low in correspondence with a large average crystal grain size.

With Comparative Example 4, the Mg content was higher than 6.0 mass %. As a result, the rollability of the aluminum alloy was reduced to a level at which the aluminum alloy was unable to be rolled.

With Comparative Example 5, the aluminum alloy contained Mg in an amount of 4.0 mass % to 6.0 mass % inclusive, whereas the 0.2% proof stress was higher than 330 MPa. This is because high work hardening occurred due to the final rolling ratio of cold rolling being high. As a result, sufficient strength required of a terminal fitting was obtained at low temperatures and high temperatures, whereas the bendability required for processing a terminal fitting was not obtained. Although Example 3 had a component composition that was close to that of Comparative Example 5, the final rolling ratio was reduced to a relatively small value, and intermediate annealing was performed, as a result of which, excessive work hardening did not occur and the 0.2% proof stress was reduced to 330 MPa or less.

Although an embodiment of the present invention has been described in detail above, the present invention is not limited to the above-described embodiment, and various modifications can be made without departing from the gist of the present invention.

### LIST OF REFERENCE NUMERALS

1 Substrate connector
10 Male terminal (terminal fitting)
11 Terminal connection portion
12 Substrate connection portion
13 Linking portion
14 Bending portion
20 Connector housing
31 Base material
32 Nickel layer
33 Tin layer

1. A terminal fitting comprising, as a base material,
an aluminum alloy that contains Mg in an amount of 4.0 mass % to 6.0 mass % inclusive, and that has a 0.2% proof stress of 290 MPa to 330 MPa inclusive.

2. The terminal fitting according to claim 1,
wherein the aluminum alloy has a breaking elongation of 10% or more.

3. The terminal fitting according to claim 1,
wherein the aluminum alloy has an average crystal grain size of 10 μm or less.

4. The terminal fitting according to claim 1,
wherein the aluminum alloy further contains Mn in an amount of 0.4 mass % to 1.8 mass % inclusive.

5. The terminal fitting according to claim 1,
wherein the terminal fitting has a coating layer that covers at least a portion of a surface of the base material, is exposed at an outermost surface, and is made of tin or a tin alloy.

6. The terminal fitting according to claim 1,
wherein the terminal fitting is a male terminal that is capable of being fitted to a female terminal,
the terminal fitting comprises a terminal connection portion configured to be electrically connected to the female terminal, a substrate connection portion configured to be inserted into a through-hole of a circuit board and be electrically connected to the through-hole through soldering, and a linking portion configured to link the terminal connection portion and the substrate connection portion, and
the linking portion has a bending portion.
